(19) United States
(12) Patent Application Publication
(10) Pub. No.: US 2017/0019806 A1
(43) Pub. Date: Jan. 19, 2017

(54) METHOD AND DEVICE FOR ADJUSTING NETWORK QUALITY OF SERVICE STRATEGIES

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Qixin HUANG, Beijing (CN)

(21) Appl. No.: 15/241,943

(22) Filed: Aug. 19, 2016

Related U.S. Application Data
(63) Continuation of application No. PCT/CN2016/082534, filed on May 18, 2016.

(30) Foreign Application Priority Data
Jul. 13, 2015 (CN) 201510409734.X

(51) Int. Cl. H04W 24/02; H04W 72/08

(52) U.S. Cl. CPC H04W 24/02; H04W 72/087

(57) ABSTRACT

Some embodiments of the present disclosure disclose a method and a device for adjusting network quality of service strategies, including: receiving a first packet from a terminal equipment, the first packet including the preset quality of service strategy of an enabled application; and adjusting a local quality of service strategy according to the preset quality of service strategy of the enabled application and obtaining an adjusted local quality of service strategy. The present disclosure implements to automatically and dynamically adjust the QoS strategies of a router equipment according to the change of an application used by the terminal equipment.

### CROSS-REFERENCE TO RELATED APPLICATIONS

This application is a continuation of PCT international application No. PCT/CN2016/082534, filed May 18, 2016, which claims priority to Chinese Patent Application No. 201510409734X, filed Jul. 13, 2015, the entire contents of which are incorporated herein by reference.

### TECHNICAL FIELD

The present disclosure relates to the field of internet technologies, and more particularly, relates to a method and a device for adjusting network quality of service strategies.

### BACKGROUND

QoS (Quality of Service, quality of service) refers to an ability of one network providing preferable services for specified network communications utilizing various basic technologies, and is configured to solve problems like network delay and congestion. In a normal case, if the network is only used for a specified application system without time limit such as Web application, Email or the like, then QoS is not needed. However, QoS is very necessary for key applications and multimedia applications. When the network is overloaded or congested, QoS can ensure that important traffics will not be delayed or discarded, and ensures the high-efficient operation of the network at the same time.

As a wireless network quality of service (Quality of Service, QoS) strategy, various network connection types and contents are usually defined. For example, a wireless multimedia (WMM, Wi-Fi Multimedia) strategy defines “voice (AC_VI)”, “video (AC_VO)”, “best-effort (AC_BE)” and “low priority data (AC_BK)” to optimize the communication quality of the wireless network, so as to ensure a stable connection established between the applications and the network resources. That is to say that high quality network connectivity for data, voice, music and video applications is provided by employing different priorities for different access types.

In the QoS strategies, although various access types are designed according to priorities from highest to lowest, there is no default priority strategy in fact; instead, a router, an AP vendor or a user selects the optimum network strategy and determines to employ the network with which kind of priority. For example, the user may incline to give the video a higher priority than the voice. The current wireless routers usually adopt a fixed QoS strategy. In the access equipment for household routers, smart mobile terminal equipment is more and more common, and the demands of different applications on the smart mobile terminal equipment on the QoS strategies of the router may be completely different. Therefore, fixed QoS strategies cannot adapt to the demands of different applications on the network QoS strategies. However, the user can only modify the configurations of the QoS strategies by frequently logging in the router when using different Apps at present, which costs a lot of time and efforts of the user.

### SUMMARY

In light of this, some embodiments of the present disclosure provide a method and a device for adjusting network quality of service strategies, which is configured to solve the technical problem that the QoS strategies of the router equipment in the prior art cannot be automatically and dynamically adjusted.

In order to solve the foregoing technical problem, the present disclosure discloses a method for adjusting network quality of service strategies applied to a router equipment, including: receiving a first packet from a terminal equipment, the first packet including the preset quality of service strategy of an enabled application; and adjusting a local quality of service strategy according to the preset quality of service strategy of the enabled application and obtaining an adjusted local quality of service strategy.

In order to solve the foregoing technical problem, the present disclosure also discloses a method for adjusting network quality of service strategies applied to a terminal equipment, including: when detecting that an application is enabled, sending a first packet to the router equipment, the first packet including the preset quality of service strategy of the enabled application, and adjusting, by the router equipment, a local quality of service strategy according to the preset quality of service strategy of the enabled application and obtaining an adjusted local quality of service strategy.

In order to solve the foregoing technical problem, the present disclosure also discloses a device for adjusting network quality of service strategies applied to a terminal equipment, including: a first receiving module configured to receive a first packet from a terminal equipment, the first packet including the preset quality of service strategy of an enabled application; and an adjustment module configured to adjust a local quality of service strategy according to the preset QoS strategy of the enabled application and obtain an adjusted local quality of service strategy.

In order to solve the foregoing technical problem, the present disclosure also discloses a device for adjusting network quality of service strategies applied to a terminal equipment, including: a first sending module configured to, when detecting that an application is enabled, send a first packet to a router equipment, the first packet including the preset quality of service strategy of the enabled application, wherein a local quality of service strategy is adjusted by the router equipment according to the preset quality of service strategy of the enabled application and an adjusted local QoS strategy is obtained.

Compared with the prior art, the method and the device for adjusting network quality of service strategies provided by some embodiments of the present disclosure implement to automatically and dynamically adjust the QoS strategies of the router equipment according to the changes of the applications used in the terminal equipment.

### BRIEF DESCRIPTION OF THE DRAWINGS

FIG. 1 is a flow chart of a method for adjusting network quality of service strategies according to some embodiments of the present disclosure;

FIG. 2 is a flow chart of a method for adjusting network quality of service strategies according to some embodiments of the present disclosure;

FIG. 3 is a flow chart of a method for adjusting network quality of service strategies according to some embodiments of the present disclosure;

FIG. 4 is a flow chart of a method for adjusting network quality of service strategies according to some embodiments of the present disclosure; and

FIG. 5 is a block diagram of a device for adjusting network quality of service strategies according to some embodiments of the present disclosure.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

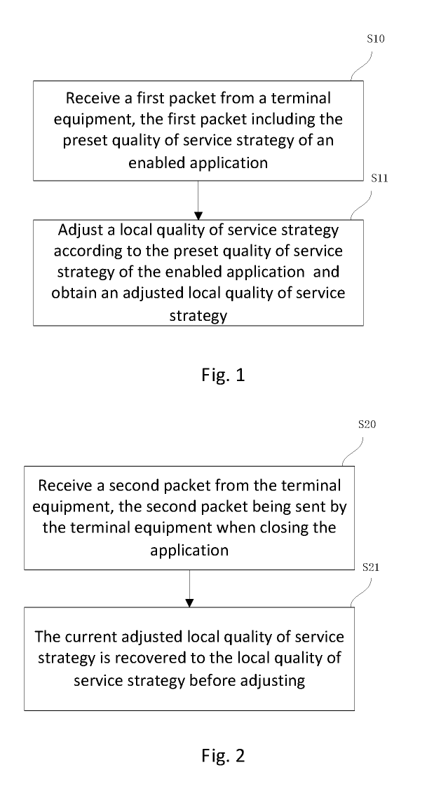

FIG. 1 is a method for adjusting network quality of service strategies applied to a router equipment according to some embodiments of the present disclosure, wherein the method includes the following steps.

In step S10, a first packet from a terminal equipment is received, wherein the first packet includes the preset quality of service strategy of an enabled application.

Different applications have different business emphases, therefore have different demands on different types of network data, thus causing that QoS strategies suitable for each application will not be completely the same. For example, some applications emphasize on voice data, while some applications emphasize on video data. Therefore, a QoS strategy suitable for the application needs to be preset for each application. The preset QoS strategy may be provided by an application developer, or distributed by an operating system of the terminal equipment or application management software installed according to the type or business emphasis of the application. After the application is enabled, the first packet sent to the router equipment by the terminal equipment includes the preset QoS strategy of the enabled application. The first packet may be a TCP (transmission control protocol, Transmission Control Protocol) packet or a UDP (user datagram protocol, User Datagram Protocol) packet. The preset QoS strategy of the enabled application is located in the data (Data) field of the TCP packet or the UDP packet. In some embodiments of the present disclosure, the QoS strategies include a DSCP (differentiated services code point, Differentiated Services Code Point) strategy, a WMM (Wi-Fi Multimedia, Wi-Fi multimedia) strategy, or the like.

In step S11, a local quality of service strategy is adjusted according to the preset quality of service strategy of the enabled application, and an adjusted local quality of service strategy is obtained.

The router equipment provides a program in an application layer to receive the packet from the terminal equipment and parse the packet data to adjust the QoS strategy of the router equipment.

The router equipment adjusts the local QoS strategy according to the preset QoS strategy in the first packet. If the router equipment has not adjusted the local QoS according to the preset QoS strategy of the application yet, then the local QoS strategy of the router equipment is a default QoS strategy, i.e., possibly the factory settings of the router equipment. The router equipment determines whether the current local QoS strategy is a default QoS strategy; if the local QoS strategy is a default QoS strategy, the local QoS strategy is adjusted to the preset QoS strategy of the enabled application so that the local QoS strategy of the router equipment can be adapted to the data demand of the enabled application to improve the network QoS. If the local QoS strategy is not a default QoS strategy, it indicates that the local QoS strategy of the router equipment is adjusted according to the preset QoS strategies of other applications; at this moment, the local QoS strategy and the preset QoS strategy are calculated according to a predetermined algorithm strategy and an adjusted local QoS strategy is obtained. For example, weighted calculation is performed on the preset QoS strategy of the enabled application to obtain the adjusted local QoS strategy, or the parameters in the local QoS strategy and the preset QoS strategy of the enabled application are averaged, thus obtaining a local QoS strategy that gives consideration to a plurality of applications as far as possible, so that the router equipment can provide preferable network quality of service for a plurality of applications at the same time.

When the application is closed, the method for adjusting network quality of service strategies, as shown in FIG. 2, further includes the following steps.

In step S20, a second packet from the terminal equipment is received, wherein the second packet is sent by the terminal equipment when closing the application.

The second packet may also be a TCP packet or a UDP packet.

In step S21, the current adjusted local QoS strategy is recovered to the local QoS strategy before adjusting.

The router equipment does not need to consider the QoS strategy of the closed application, thus removing the influence of the preset QoS strategy of the closed application on the local QoS strategy, and enabling the local QoS strategy to be possibly suitable for other applications that are not closed. When recovering the current adjusted local QoS strategy to the QoS strategy before adjusting, if the local QoS strategy is a default QoS strategy before adjusting, then the local QoS strategy is recovered to the default QoS strategy; if the local QoS strategy is not a default QoS strategy before adjusting, then the local QoS strategy is recovered to the local QoS strategy before adjusting. Therefore, the local QoS strategy recovered is suitable for the network demands of other applications as far as possible, so that the router equipment keeps higher network quality of service.

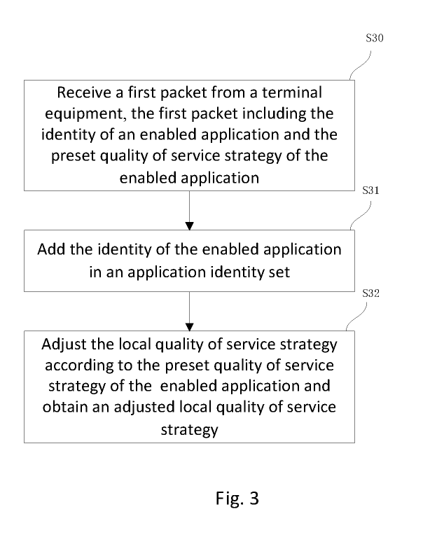

FIG. 3 is a method for adjusting network quality of service strategies applied to a router equipment according to some embodiments of the present disclosure, wherein the method includes the following steps.

In step S30, a first packet from a terminal equipment is received, wherein the first packet includes the identity of an enabled application and the preset quality of service strategy of the enabled application.

The first packet is sent by the terminal equipment when detecting that an application is enabled. The first packet includes the identity of the enabled application, and the identity is configured to distinguish different applications. The first packet further includes the preset QoS strategy of the enabled application. Different applications have different business emphasis, therefore have different demands on different types of network data, thus causing that QoS strategies suitable for each application will not be completely the same. For example, some applications emphasize on voice data, while some applications emphasize on video data. Therefore, a QoS strategy suitable for the application needs to be preset for each application. The preset QoS strategy may be provided by an application developer, or distributed by an operating system of the terminal equipment or application management software installed according to the type or business emphasis of the application. After the application is enabled, the first packet sent to the router equipment by the terminal equipment includes the preset QoS strategy of the enabled application. The first packet may be a TCP (transmission control protocol, Transmission Control Protocol) packet or a UDP (user datagram protocol, User Datagram Protocol) packet. The identity and the preset QoS strategy of the enabled application are located in the data (Data) field of the TCP packet or the UDP packet. In some embodiments of the present disclosure, the QoS strategies include a DSCP (differentiated services code point, Differentiated Services Code Point) strategy, a WMM (Wi-Fi Multimedia, Wi-Fi multimedia) strategy, or the like.

The router equipment provides a program in an application layer to receive the packet from the terminal equipment and parse the packet data to adjust the QoS strategy of the router equipment.

In step S31, the identity of the enabled application is added to an application identity set.

The application identity set is configured to record applications running by each terminal equipment. The router equipment parses the identity of the enabled application from the first packet, and adds the identity of the enabled application to the application identity set.

In step S32, the local quality of service strategy is adjusted according to the preset quality of service strategy of the enabled application and an adjusted local quality of service strategy is obtained.

The router equipment adjusts the local QoS strategy according to the preset QoS strategy in the first packet. If the router equipment has not adjusted the local according to the preset QoS strategy of the application, then the local QoS strategy of the router equipment is a default QoS strategy, i.e., possibly the factory settings of the router equipment. The router equipment judges whether the current local QoS strategy is a default QoS strategy; if the local QoS strategy is a default QoS strategy, the local QoS strategy is adjusted to the preset QoS strategy of the enabled application so that the local QoS strategy of the router equipment can be adapted to the data demand of the enabled application to improve the network QoS. If the local QoS strategy is not a default QoS strategy, it indicates that the local QoS strategy of the router equipment is adjusted according to the preset QoS strategies of other applications; in the application identity set, the identities of other applications enabled are also included besides the identity of the enabled application that is added in step S11; at this moment, weighted calculation is performed on the preset QoS strategies of a plurality of applications in the application identity set to obtain an adjusted local QoS strategy. For example, the weighted values of the preset QoS strategies of the various applications may be determined according to the application categories, and then the adjusted local QoS strategy is calculated according to the weighted values, or the parameters in the preset QoS strategies of the plurality of applications are averaged, thus obtaining a local QoS strategy that gives consideration to a plurality of applications as far as possible, so that the router equipment can provide preferable network quality of service for the plurality of applications at the same time.

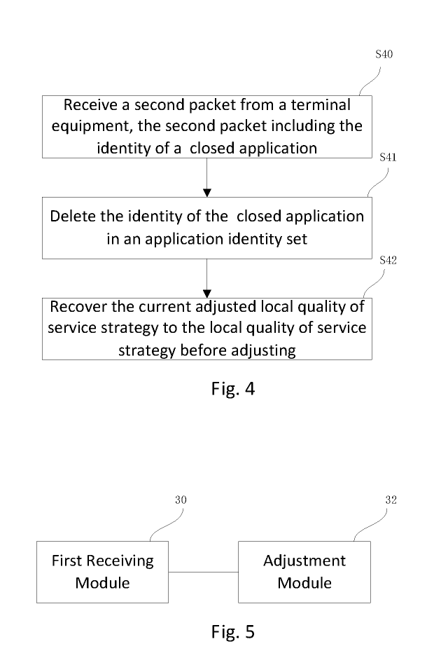

When the application is closed, the method for adjusting quality of service strategies, as shown in FIG. 4, further includes the following steps.

In step S40, a second packet from a terminal equipment is received, wherein the second packet includes the identity of the closed application.

When the terminal equipment has an application that is closed, the terminal equipment sends the second packet to a router equipment. The second packet may also be a TCP packet or a UDP packet, including the identity of the closed application, and the identity of the closed application is located in the data (Data) field of the TCP packet or the UDP packet.

In step S41, the identity of the closed application is deleted from an application identity set.

The router equipment parses the identity of the closed application from the second packet, and deletes the identity of the closed application.

In step S42, the current adjusted local QoS strategy is recovered to the local quality of service strategy before adjusting.

The router equipment does not need to consider the QoS strategy of the closed application, thus removing the influence of the preset QoS strategy of the closed application on the local QoS strategy, and enabling the local QoS strategy to be suitable for other applications in the application identity set as far as possible. When recovering the current adjusted local quality of service strategy to the local quality of service strategy before adjusting, whether the application identity set includes the identity of any application already is determined firstly. If the application identity set does not include the identity of any application, the local QoS strategy is recovered to the default QoS strategy; if the application identity set still includes the identity of other application, inverse operation of weighted calculation is performed on the local QoS strategy according to the preset QoS strategy of the closed application to obtain a recovered local QoS strategy. For example, the inverse operation of weighted calculation may be to calculate the preset QoS strategies of all other applications in the application identity set according to the respective weighted values, or average various parameters of the preset QoS strategies of all other applications in the application identity set, thus enabling the recovered local QoS strategy to be possibly suitable for the network demands of other applications in the application identity set, so that the router equipment keeps higher network quality of service.

Some embodiments of the present disclosure also provide a method for adjusting network quality of service strategies applied to a terminal equipment, including: when detecting that an application is enabled, sending a first packet to a router equipment, the first packet including the preset quality of service strategy of the enabled application, and adjusting, by the router equipment, a local quality of service strategy according to the preset quality of service strategy of the enabled application and obtaining an adjusted local quality of service strategy.

The terminal equipment detects the enabling and closing of the applications, and the preset QoS strategies of various applications may either be provided by application developers or distributed by an operating system of the terminal equipment or application management software installed according to the types or business emphases of the applications. When the terminal equipment sends the first packet to the router equipment, a communications interface of the enabled application, a communications interface of the application management software installed, or a communications interface of the operating system may be utilized to conduct data communication with the router equipment. The router equipment adjusts the local QoS strategy according to the preset QoS strategy of the enabled application in the first packet to enable the adjusted local QoS strategy to be suitable for the enabled application as far as possible.

The method for adjusting network quality of service strategies further includes: when detecting that the application is closed, sending a second packet to the router equipment, and recovering, by the router equipment, the current adjusted local quality of service strategy to the local quality of service strategy before adjusting.

When detecting that an application is closed, the second packet may be sent to the router equipment through a communications interface of the application at the same time when the application is closed, and the second packet may also be sent to the router equipment through the communications interface of the application management software installed or the communications interface of the operating system. The router equipment recovers the current adjusted local QoS strategy to the local QoS strategy before adjusting, removes the influences of the preset QoS strategy of the closed application on the local QoS strategy of the router equipment, and enables the recovered local QoS strategy to be suitable for other applications that are not closed as far as possible.

In some embodiments, some embodiments of the present disclosure also provide a method for adjusting network quality of service strategies applied to a terminal equipment, including: when detecting that an application is enabled, sending a first packet to a router equipment, the first packet including the identity of the enabled application and the preset quality of service strategy of the enabled application, adding, by the router equipment, the identity of the enabled application to an application identity set, and adjusting a local quality of service strategy according to the preset quality of service strategy of the enabled application and obtaining an adjusted local quality of service strategy.

The terminal equipment detects the enabling and closing of the applications, and the preset QoS strategies of various applications may either be provided by application developers or distributed by an operating system of the terminal equipment or application management software installed according to the types or business emphases of the applications. When the terminal equipment sends the first packet to the router equipment, a communications interface of the enabled application, a communications interface of the application management software installed, or a communications interface of the operating system may be utilized to conduct data communication with the router equipment. The router equipment adjusts the local QoS strategy according to the identity of the enabled application and the preset QoS strategy of the enabled application in the first packet to enable the adjusted local QoS strategy to be suitable for the enabled application as far as possible.

The method for adjusting network quality of service strategies further includes: when detecting an application is closed, sending a second packet to the router equipment, the second packet including the identity of the closed application, deleting, by the router equipment, the identity of the closed application in the application identity set, and removing the preset quality of service strategy of the closed application from the local quality of service strategy.

When detecting that an application is closed, the second packet may be sent to the router equipment through a communications interface of the application at the same time when the application is closed, and the second packet may also be sent to the router equipment through the communications interface of the application management software installed or the communications interface of the operating system. The router equipment deletes the identity of the closed application in the application identity set, thus removing the influence of the preset QoS strategy of the application on the local QoS strategy, and enabling the recovered QoS strategy to be suitable for other remaining applications that are not closed in the application identity set as far as possible.

Some embodiments of the present disclosure are further explained hereinafter through several application examples.

(I) Adjust the DSCP Strategy of the Router Equipment

The DSCP strategy includes a plurality of parameters like AF (assured forwarding, Assured Forwarding), EF (expedited forwarding, Expedited Forwarding). Taking the EF parameter of the DSCP strategy of the router equipment for example, the EF parameter is mainly used for such businesses with low delay, low jitter and low packet loss probability. These businesses usually need relatively stable rates, and need quick forwarding in a forwarding equipment. The default DSCP value of the EF parameter is 46.

When the terminal equipment enables an application A mainly used for internet phone function, because higher instantaneity and low jitter of data needs to be ensured for the internet phone, the DSCP value of an EF parameter in the preset DSCP strategy of the application A is 56; the terminal equipment sends a first packet to the router equipment, wherein the first packet includes the identity of the application A, for example, “app_A”, and the preset DSCP strategy of the application A, wherein the DSCP value of the EF parameter is 56. The router equipment, after receiving the first packet, adds the identity of the application A “app_A” to the application identity set. Then, the router equipment determines that the current local DSCP strategy is a default DSCP strategy; therefore, the local DSCP strategy is adjusted to the preset DSCP strategy of the application A, and the EF parameter of the local DSCP strategy of the router equipment is adjusted to 56 from 46, so that the priority of expedited forwarding becomes higher, and the network services are more beneficial for the application A mainly focusing on internet phone business.

When an application B emphasizing on video playing business in the terminal equipment is enabled, the DSCP value of an EF parameter in the preset DSCP strategy of the application B is 46; the terminal equipment sends a first packet to the router equipment again, wherein the first packet includes the identity of the application B “app_B” and the preset DSCP strategy of the application B. The router equipment, after receiving the first packet, adds the identity of the application B “app_B” to the application identity set and determines that the current local DSCP strategy is not a default DSCP strategy; then weighed average is performed on various parameters in the local DSCP strategy and the preset DSCP strategy of the application B. For the EF parameter therein, after the weighted average, the DSCP value is 51, and the DSCP value of the EF parameter in the local DSCP strategy of the router equipment is adjusted to 51, so as to satisfy the demands of the application A and the application B on the network QoS at the same time as far as possible.

When the application B in the terminal equipment is closed, the terminal equipment sends a second packet to the router equipment, wherein the second packet includes the identity of the application B “app_B”. The router equipment, after receiving the second packet, deletes the identity of the application B “app_B” from the application identity set, and determines that the application identity set further includes the identity of another application A, then the router equipment conducts inverse operation of weighted average on various parameters in the local DSCP strategy according to the preset DSCP strategy of the application B, and the DSCP value of the EF parameter is recovered to the DSCP value of the EF parameter in the preset DSCP strategy of the application A, i.e., adjusted to 56 from 51, so that the DSCP strategy of the router equipment is more suitable for the demand of the application A on the network quality of service.

When the application A in the terminal equipment is also closed, the terminal equipment sends a second packet to the router equipment again, wherein the second packets includes the identity of the application A “app_A”. The router equipment, after receiving the second packet, deletes the identity of the application A “app_A” from the application identity set, and determines that the application identity set does not include the identity of any application, then the router equipment recovers the local DSCP strategy to a default DSCP strategy; for the EF parameter in the DSCP strategy, the DSCP value of the EF parameter is recovered to the default value 46 from 56.

(II) Adjust the WMM Strategy of the Router Equipment

The WMM strategy includes a plurality of parameters like AIFSN (Arbitration Inter Frame Spacing Number, arbitration inter frame spacing number), CWMIN (Contending Windows MIN, contending windows minimum), CWMAX (Contending Windows MAX, contending windows maximum). Herein, the AIFSN is taken as an example for the purpose of explanation, and the adjusting principles for other parameters are the same. The smaller the AIFSN is (i.e., the shorter the time of waiting for an channel to be idle is), the easier the channel access is. Therefore, the AIFSN value of a low priority business is greater than that of a high priority business.

For example, a video application usually possesses highest priority of video streaming Supposing a WMM strategy needed by the video application is as shown in Table 1 below:

TABLE 1

| AC | AIFSN |
|---|---|
| Voice | 3 |
| Video | 1 |
| Best-effort | 5 |
| Back-ground | 7 |

wherein, Voice represents the priority of a voice business, Video represents the priority of video business data, Best-effort represents the priority of “best-effort” type of business data, and Back-ground represents the priority of lower priority background data.

When the video application of the terminal equipment is enabled, the terminal equipment sends the preset WMM strategy of the video application to a wireless router.

The wireless router receives the first packet sent from the terminal equipment, and adds the identity of the video application to the application identity set. The wireless router checks the current local WMM strategy. If the current local WMM strategy is a default WMM strategy, it indicates that there is temporarily no demand on the preset WMM strategies of other applications, then settings are performed directly according to the preset WMM strategy of the video application.

If the wireless router finds that the local WMM strategy has already been adjusted according to the preset WMM strategies of other applications, then weighted average needs to be performed on the preset WMM strategies of a plurality of applications to calculate an adjusted WMM strategy. For example, one voice application is already connected to the wireless router, and the preset WMM strategy of the voice application is as shown in Table 2 below:

TABLE 2

| AC | AIFSN |
|---|---|
| Voice | 1 |
| Video | 5 |
| Best-effort | 7 |
| Back-ground | 7 |

At this moment, weighted average calculation needs to be performed on the preset WMM strategies of the newly added video application and the voice application, wherein a formula is: target value=AVERAGE (parameter 1, parameter 2, . . . )

The adjusted WMM strategy after calculation is obtained as follows:

TABLE 3

| AC | AIFSN |
|---|---|
| Voice | 2 |
| Video | 3 |
| Best-effort | 6 |
| Back-ground | 7 |

When the video application is closed, the terminal equipment needs to notify an event of closing the video application to the wireless router and sends a second packet to the wireless router. The wireless router, after receiving the second packet, removes the preset WMM strategy of the video application from the current local WMM strategy. For example, the WMM strategy with the weighted average of the voice application and the video application is as shown in Table 3. When the video application is closed, the local WMM strategy of the wireless router performs inverse operation of weighted average on the preset WMM strategy of the video application, and the re-calculated local WMM strategy is as shown in Table 4 below:

TABLE 4

| AC | AIFSN |
|---|---|
| Voice | 1 |
| Video | 5 |
| Best-effort | 7 |
| Back-ground | 7 |

The local WMM strategy of the wireless router is recovered to the local WMM strategy before adding the video application.

FIG. 5 is a device for adjusting network quality of service strategies according to some embodiments of the present disclosure, including:

a first receiving module 30 configured to receive a first packet from a terminal equipment, the first packet including the preset quality of service strategy of an enabled application; and

an adjustment module 32 configured to adjust a local quality of service strategy according to the preset quality of service strategy of the enabled application and obtain an adjusted local quality of service strategy.

The adjustment module 32 includes:

a determination submodule configured to determine whether the local quality of service strategy is a default quality of service strategy;

a first adjustment submodule configured to, if the local quality of service strategy is a default quality of service strategy, adjust the local quality of service strategy to the preset quality of service strategy of the enabled application; and

a second adjustment submodule configured to, if the local quality of service strategy is not a default quality of service strategy, calculate the local quality of service strategy and the preset quality of service strategy according to a predetermined algorithm strategy, and obtain the adjusted local quality of service strategy.

In some embodiments, the device also further includes:

a second receiving module configured to receive a second packet from the terminal equipment, the second packet being sent by the terminal equipment when closing the application; and

a recovery module configured to recover the current adjusted local quality of service strategy to the local quality of service strategy before adjusting.

In some embodiments, the first packet further includes the identity of the enabled application, and the device further includes:

an addition module configured to, after receiving the first packet, add the identity of the enabled application to an application identity set; and

a deletion module configured to, after receiving the second packet, delete the identity of the closed application from the application identity set.

Some embodiments of the present disclosure also provides a device for adjusting network quality of service strategies, including:

a first sending module configured to, when detecting that an application is enabled, send a first packet to a router equipment, the first packet including the preset quality of service strategy of the enabled application, and a local quality of service strategy being adjusted by the router equipment according to the preset quality of service strategy of the enabled application to obtain an adjusted local quality of service strategy.

In some embodiments, the device also further includes:

a second sending submodule configured to, when detecting that the application is closed, send a second packet to the router equipment, the current adjusted local QoS strategy being recovered to the local quality of service strategy before adjusting by the router equipment.

Furthermore, each functional module above in some embodiments of the present disclosure can be implemented through a hardware processor (hardware processor).

It may be understood by those having ordinary skills in the art that the all or a part of steps of implementing the foregoing embodiments may be finished through relevant hardware instructed by a program. The program may be stored in a mobile device or a computer readable storage medium, and the program while performing includes the steps of the foregoing embodiments of the method. While the forementioned storage medium includes: various mediums that can store program codes such as ROM, RAM, magnetic disk or optical disk.

It should be finally noted that all some embodiments above are only configured to explain the technical solutions of the present disclosure, but are not intended to limit the protection scope of the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part or whole of technical features thereof, and these modifications or substitutions will not make the essence of the corresponding technical solutions depart from the scope of the technical solutions of some embodiments of the present disclosure.

What is claimed is:

1. A method for adjusting network quality of service strategies applied to a router equipment, comprising:
receiving a first packet from a terminal equipment, the first packet comprising a preset quality of service strategy of an enabled application; and
adjusting a local quality of service strategy according to the preset quality of service strategy of the enabled application and obtaining an adjusted local quality of service strategy.

2. The method according to claim 1, wherein the adjusting the local quality of service strategy according to the preset quality of service strategy of the enabled application and obtain the adjusted local quality of service strategy comprises:
determining whether the local quality of service strategy is a default quality of service strategy;
if the local quality of service strategy is a default quality of service strategy, adjusting the local quality of service strategy to the preset quality of service strategy of the enabled application; and
if the local quality of service strategy is not a default quality of service strategy, calculating the local quality of service strategy and the preset quality of service strategy according to a predetermined algorithm strategy and obtaining the adjusted local quality of service strategy.

3. The method according to claim 1, further comprising:
receiving a second packet from the terminal equipment, the second packet being sent by the terminal equipment when closing the application; and
recovering the current adjusted local quality of service strategy to the local quality of service strategy before adjusting.

4. The method according to claim 2, wherein the calculating the local quality of service strategy and the preset quality of service strategy according to the predetermined algorithm strategy and obtaining the adjusted local quality of service strategy comprises:
performing weighted calculation on the local quality of service strategy and the preset quality of service strategy and obtaining the adjusted local quality of service strategy.

5. The method according to claim 1, wherein the first packet further comprises the identity of the enabled application; and before the adjusting the local quality of service strategy according to the preset quality of service strategy of the enabled application, the method further comprises:
adding the identity of the enabled application to an application identity set.

6. A device for adjusting network quality of service strategies, comprising:
at least one processor; and
a memory communicably connected with the at least one processor for storing instructions executable by the at least one processor, wherein execution of the instructions by the at least one processor causes the at least one processor to:
receive a first packet from a terminal equipment, the first packet comprising the preset quality of service strategy of an enabled application; and
adjust a local quality of service strategy according to the preset quality of service strategy of the enabled application and obtain an adjusted local quality of service strategy.

7. The device according to claim 6, wherein the adjust the local quality of service strategy according to the preset quality of service strategy of the enabled application and obtain the adjusted local quality of service strategy comprises:
determine whether the local quality of service strategy is a default quality of service strategy;
if the local quality of service strategy is a default quality of service strategy, adjust the local quality of service strategy to the preset quality of service strategy of the enabled application; and
if the local quality of service strategy is not a default quality of service strategy, calculate the local quality of service strategy and the preset quality of service strategy according to a predetermined algorithm strategy and obtain the adjusted local quality of service strategy.

8. The device according to claim 6, wherein the at least one processor is further caused to:
receive a second packet from the terminal equipment, the second packet being sent by the terminal equipment when closing the application; and
recover the current adjusted local quality of service strategy to the local quality of service strategy before adjusting.

9. The device according to claim 7, wherein the calculate the local quality of service strategy and the preset quality of service strategy according to the predetermined algorithm strategy and obtain the adjusted local quality of service strategy comprises:
perform weighted calculation on the local quality of service strategy and the preset quality of service strategy and obtain the adjusted local quality of service strategy.

10. The device according to claim 6, wherein the first packet further comprises the identity of the enabled application; and the at least one processor is further caused to:
add the identity of the enabled application to an application identity set.

11. A device for adjusting network quality of service strategies, comprising:
at least one processor; and
a memory communicably connected with the at least one processor for storing instructions executable by the at least one processor, wherein execution of the instructions by the at least one processor causes the at least one processor to:
when detecting that an application is enabled, send a first packet to a router equipment, the first packet comprising the preset quality of service strategy of the enabled application, wherein the router equipment adjusts a local quality of service strategy according to the preset quality of service strategy of the enabled application and obtains an adjusted local quality of service strategy.

12. The device according to claim 11, wherein the at least processor is further caused to:
when detecting that the application is closed, send a second packet to the router equipment, the current adjusted local quality of service strategy being recovered to the local quality of service strategy before adjusting by the router equipment.

13. A non-transitory computer-readable storage medium storing executable instructions that, when executed by an electronic device, cause the electronic device to perform the method according to claim 1.
